(19) United States
(12) Patent Application Publication
(10) Pub. No.: US 2010/0207006 A1
(43) Pub. Date: Aug. 19, 2010

(54) SUPPORTING APPARATUS FOR DISPLAY DEVICE

(76) Inventor: Hyo Jun Kim, Pyeongtaek-si (KR)

Correspondence Address: KED & ASSOCIATES, LLP, P.O. Box 221200, Chantilly, VA, 20153-1200, US

(21) Appl. No.: 12/738,922

(22) PCT Filed: Oct. 15, 2008
(86) PCT No.: PCT/KR08/06088

§ 371 Date: Apr. 20, 2010

(30) Foreign Application Priority Data
Oct. 22, 2007 (KR) 10-2007-0106152

(51) Int. Cl. F16M 13/00

(52) U.S. Cl. 248/625; 248/284.1

(57) ABSTRACT

Provided is a supporting apparatus for a display device. The supporting apparatus includes a fixing bracket, a set bracket, and a connecting assembly. The set bracket is connected to the display device and is capable of tilting with respect to the fixing bracket. The connecting assembly is connecting the set bracket and the fixing bracket. The connecting assembly includes a tension member generating biasing force over a portion of a tilting range of the display device.

### TECHNICAL FIELD

The present disclosure relates to a supporting apparatus for a display device.

### BACKGROUND ART

In general, display devices are apparatuses for displaying images. Recently, various types of two-dimensionally flat display devices that are formed as flat as possible are being made. Because such flat display devices consume little interior space, are lightweight, and are easy to handle, they have attracted much consumer interest.

These display devices can be used fixed to a wall by means of a supporting apparatus, or can be used in a floor-standing configuration supported by a supporting apparatus. Present embodiments relate to a supporting apparatus for installing a display device on a wall.

### DISCLOSURE OF INVENTION

### Technical Problem

Embodiments provide a supporting apparatus for a display device.

### Technical Solution

In one embodiment, a supporting apparatus for a display device includes: a fixing bracket; a set bracket connected to the display device and capable of tilting with respect to the fixing bracket; and a connecting assembly connecting the set bracket and the fixing bracket, wherein the connecting assembly includes a tension member generating biasing force over a portion of a tilting range of the display device.

In another embodiment, a supporting apparatus for a display device includes: a fixing bracket; a set bracket connected to the display device to be capable of tilting with respect to the fixing bracket; a connecting member pivotably connecting the set bracket and the fixing bracket; a supporting member pivotably connected to the connecting member and the fixing bracket; and a tension member selectively generating biasing force during tilting of the display device, wherein the display device is capable of tilting in both directions, the tension member moves elastically in one direction within a predetermined tilting range during tilting of the display device in the one direction, and the tension member moves elastically in the opposite direction within a predetermined tilting range during tilting of the display device in the opposite direction.

### BRIEF DESCRIPTION OF THE DRAWINGS

FIG. 1 is a side view of a supporting apparatus for a display device according to present embodiments.

FIG. 2 is a perspective view of a supporting apparatus with an upper end of a set bracket pivoted downward.

FIG. 3 is a graph showing the dynamics of a first connecting assembly.

FIG. 4 is a side view of a supporting apparatus for a display device according to present embodiments showing the lower end of the display device moved upward.

FIG. 5 is a rear perspective view of a supporting apparatus according to present embodiments.

FIG. 6 is a perspective view of a supporting apparatus showing a lower end of a set bracket pivoted upward.

FIG. 7 is a perspective view of a tension member of a second connecting assembly according to present embodiments.

FIG. 8 is a graph showing the relationship between force and movement of the lower end of a display device.

FIG. 9 is a perspective view showing the configuration of a second connecting assembly according to present embodiments.

### MODE FOR THE INVENTION

Reference will now be made in detail to the embodiments of the present disclosure, examples of which are illustrated in the accompanying drawings.

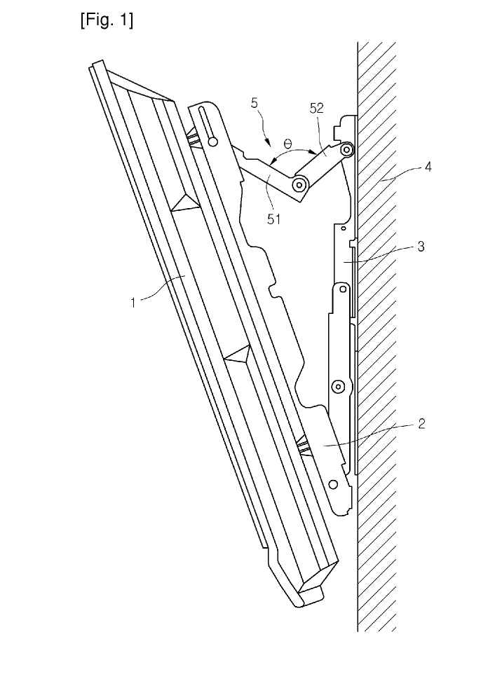

FIG. 1 is a side view of a supporting apparatus for a display device according to present embodiments, where the upper end of the display device is moved downward.

Referring to FIG. 1, a supporting apparatus according to present embodiments includes a set bracket 2 on which a display device 1 is mounted, a fixing bracket 3 installed in a fixed position such as on a wall, and a first connecting assembly 5 and a second connecting assembly 6 (in FIG. 4) connecting the respective upper and lower portions of the fixing bracket 3 and the set bracket 2 through hinges. The first connecting assembly 5 enables the upper portion of the set bracket 2 to tilt with respect to the fixing bracket 3, and the second connecting assembly 6 (in FIG. 4) enables the lower portion of the set bracket 2 to tilt with respect to the fixing bracket 3. Accordingly, the first connecting assembly 5 may be referred to as an upper connecting assembly, and the second connecting assembly 6 (in FIG. 4) may be referred to as a lower connecting assembly.

Also, in order to maintain lateral equilibrium, the first connecting assembly 5 and the second connecting assembly 6 (in FIG. 4) may respectively be provided in pairs at the left and right.

The first connecting assembly 5 gradually exerts a predetermined amount of biasing force according to the downward pivoting of the display device 1, so that resistance may be applied against the moment due to the weight of the display device 1.

Moreover, when the display device 1 that is tilted downward needs to be pivoted upward, the stored biasing (tensile) force enables the display device 1 to be pivoted more easily upward. Thus, a user can more conveniently pivot the upper end of the display device 1 upward or downward.

Therefore, because the first connecting assembly 5 is provided with a function of equalizing the weight of the display device 1, the assembly may be referred to as a weight balancer.

As a structure for performing such a function of weight balancing, the first connecting assembly 5 includes a first arm 51 and a second arm 52 with a tension member 53 interposed therebetween.

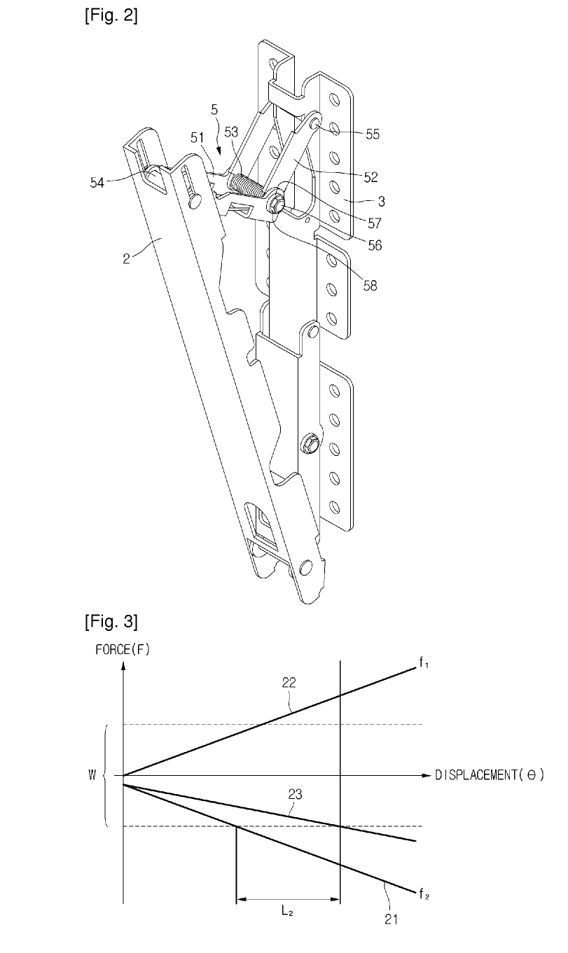

FIG. 2 is a perspective view of a supporting apparatus with an upper end of a set bracket pivoted downward.

Referring to FIG. 2, the first arm 51 is supported by a first shaft 54 on the set bracket 2, and the second arm 52 is supported by a second shaft 55 on the fixing bracket 3.

Also, the first shaft 54 is pivotably connected to the first arm 51, and the second shaft 55 is pivotably connected to the second arm 52. Accordingly, the first arm 51 can pivot with respect to the set bracket 2, and the second arm 52 can pivot with respect to the fixing bracket 3.

The first arm 51 and the second arm 52 are coupled in a hinge configuration by means of a hinge shaft 56. The hinge shaft 56 is formed as a bolt, and a nut 58 is coupled at the end opposite to the bolt head, with a washer 57 in between. The nut 58 controls the amount of friction and kinetic friction generated by the hinge shaft 56, washer 57, etc. The head of the hinge shaft 56 may be provided with a wrench socket that allows a user to conveniently adjust the friction.

Also, the tension member 53 is wound around the outer periphery of the hinge shaft 56. The tension member 53 imparts biasing force in the folding direction of the first arm 51 and the second arm 52. That is, the tension member 53 exerts force for raising the upper end of the display device 1 in an upward direction.

The dynamics of the above-described first connecting assembly 5 will be set forth below.

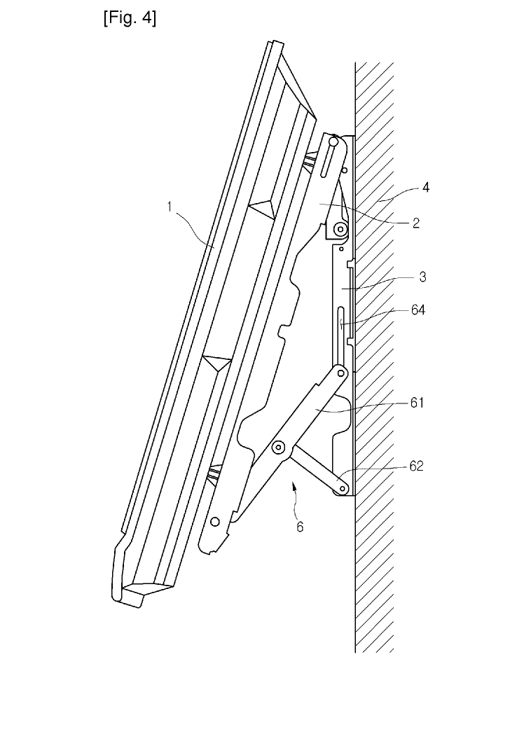

FIG. 3 is a graph showing the dynamics of a first connecting assembly.

In FIG. 3, the horizontal axis represents the opening angle of a first connecting assembly, and the vertical axis represents force generated according to the angle.

Referring to FIG. 3, line 22 represents a force f₁ of a moment imparted by the tension member 53 for pivoting the upper end of the display device upward, and line 21 represents a force f₂ of a moment of a tendency of the upper end of the display portion to pivot downward due to the weight of the device when its downward pivoting is initiated. Line 23 represents the resultant force of forces f₁ and f₂.

Thus, according to FIG. 3, in order for a user to tilt the upper end of the display device upward, a force exceeding the upper limit of a static friction range (W) for line 23 must be exerted upward. Conversely, to tilt the upper end of the display device downward, a force exceeding the lower limit of the static friction range (W) for line 23 must be exerted downward. The point at which the lower limit of the static friction range (W) is exceeded may be viewed as the point where pivoting of the display device is begun by the moment of weight even when there is no external force exerted on the display device—in other words, the point at which auto-tilting begins. In order to increase this range in the related art, the range of static friction (W) is widened by correspondingly increasing the level of friction.

Of course, this line graph only depicts approximate moments, and even when there is no displacement, the tension member may exhibit a certain degree of a moment. Thus, while various displacements are possible, such as the tilt of line 22 being altered through changing the tension coefficient of the tension member, FIG. 3 schematically shows the basic principle to facilitate understanding of the operation of the first connecting assembly according to the present embodiment.

To further describe FIG. 3, if the tension member 53 were not present, a force corresponding to the distance between line 21 and the upper limit of the static friction range (W) would have to be exerted. However, if the tension member is added, the force that a user needs to exert for pivoting the upper end of the display device upward can be reduced. Although the static frictional force is small, the range by which the display device can be prevented from auto-tilting can be increased by L₂. While there is a need to set static friction to a high level in order to obtain a predetermined pivot angle of related art display devices, the present disclosure has the advantage of not requiring high static friction, so that the static friction can be set at a low level, which enables a user to conveniently adjust the pivot angle of the display device.

FIG. 4 is a side view of a supporting apparatus for a display device according to present embodiments showing the lower end of the display device moved upward.

Referring to FIG. 4, the second connecting assembly 6 includes a connecting member 61 connecting a set bracket 2 and a fixing bracket 3, and a supporting member 62 connected to the connecting member 61 and the fixing bracket 3 to support the connecting member 61. The supporting member 62 is connected to the central portion of the connecting member 61.

That is, the second connecting assembly 6 operates through the supporting member 62 supporting the connecting member 61.

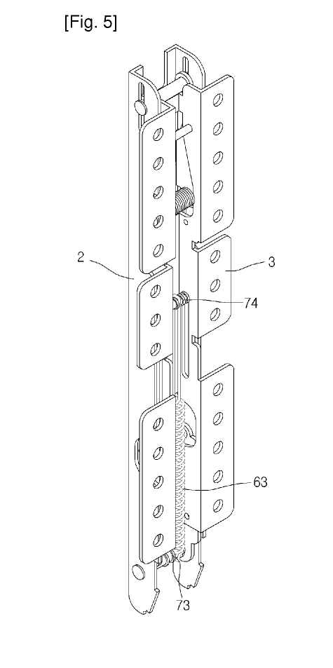

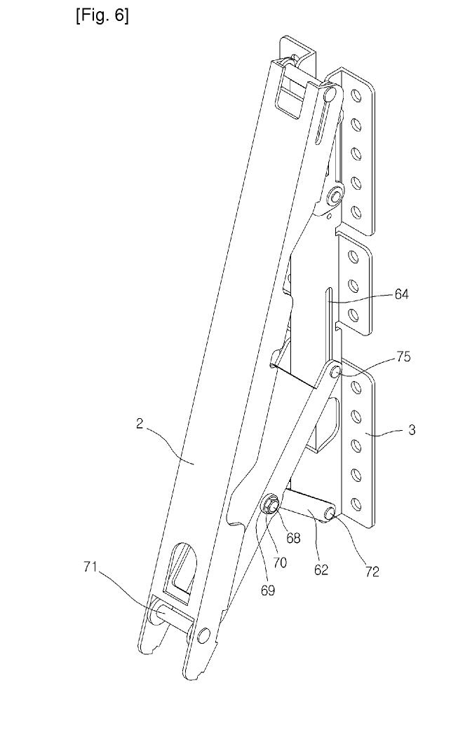

FIG. 5 is a rear perspective view of a supporting apparatus according to present embodiments, and FIG. 6 is a perspective view of a supporting apparatus showing a lower end of a set bracket pivoted upward.

Referring to FIGS. 5 and 6, the second connecting assembly 6 includes a connecting member 61 and a supporting member 62.

The connecting member 61 is connected to the fixing bracket 3 by a guide shaft 75. The guide shaft 75 guides the connecting member 61 to pivot with respect to the fixing bracket 3.

The connecting member 61 is connected to the set bracket 2 through a first shaft 71. The first shaft 71 guides the connecting member 61 to pivot with respect to the set bracket 2.

A slot 64 is formed in the fixing bracket 3 to guide vertical movement of the guide shaft 75. Accordingly, the guide shaft 75 moves upward and downward within the slot 64 while inserted in the slot 64.

One end of the supporting member 62 is connected to the connecting member 75 through a hinge shaft 68 to be capable of pivoting, and the other end is connected to the fixing bracket 3 through a second shaft 72 to be capable of pivoting.

The hinge shaft 68 is configured as a bolt, where a nut 70 is tightened on the end opposite the head of the bolt, with a washer 69 inserted in between, to be capable of controlling frictional force. The head of the hinge shaft 68 may have a wrench socket provided to allow a user to conveniently adjust frictional force.

Also, a first guide member 74 is installed on the guide shaft 75, and a second guide member 73 is installed on the second shaft 72. A tension member 63 is supported on each of the guide members 73 and 74.

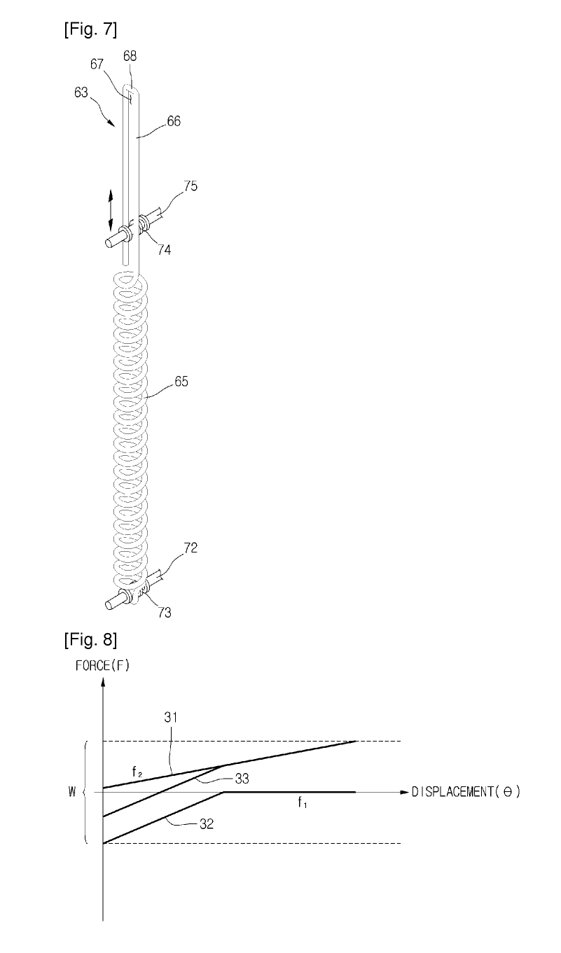

FIG. 7 is a perspective view of a tension member of a second connecting assembly according to present embodiments.

Referring to FIG. 7, the tension member 63 includes a tension portion 65 that moves elastically, and a guide portion 66 that guides the guide shaft 75 without applied tension. The tension portion 65 is configured as a coil. The tension portion 65 moves elastically in a direction other than a tilting direction of the display device—that is, in a vertical direction.

The guide portion 66 extends upward from the upper end of the tension portion 65, after which it is bent to extend back down. That is, the guide portion 66 is formed substantially in an inverse “U” shape. Also, the guide portion 66 defines a space 67 in which the guide shaft 75 can move.

While the guide shaft 75 moves, the guide shaft 75 contacts the bent portion 68 of the guide portion 66, and the guide portion 66 moves together with the guide shaft 75.

The tension member 63 may be divided into a portion that imparts biasing force according to the movement of the guide shaft 75, and a portion that does not impart biasing force.

In detail, when the display device 1 is completely disposed against a wall, the guide shaft 75 is not only moved completely toward the bent portion 68 of the guide portion 66, but also moves together with the bent portion 68 (when moved against the bent portion 68) to expand the tension part 65 (in an expanded state). The expanded state is shown in FIG. 5, in which the guide shaft 75 is moved completely upward in the slot 64.

From this state, when the lower end of the display device 1 is gradually moved upward, the guide shaft 75 begins to move gradually downward, and here, the tension portion 65 gradually begins to contract, so that ultimately, the tension portion 65 is completely contracted (in a contracted state).

Then, when the lower end of the display device 1 is continuously moved upward, the guide shaft 75 moves within the guide portion 66 (in an idle state) without being influenced by the movement of the tension portion 65.

Specifically, the region in which movement from the expanded state to the contracted state occurs is a region in which the biasing force of the tension member is imparted, and conversely, the region in which movement from the contracted state to the expanded state occurs is a region in which biasing force of the tension member is stored. Also, the idle state is independent of the biasing force of the tension member.

A description of the effects of the above tension member 63 will be provided in connection with when a user performs the act of moving the lower end of the display device.

First, from a state such as that in FIG. 5 (where the display device is disposed perpendicular to a floor), when the lower end of the display device is initially pulled, the biasing force imparted by the tension spring enables the lower end of the display device to be easily moved upward. Then, after a contracted state is assumed, the entirety of the biasing force of the tension member is consumed, and operation is performed only through the static friction of the hinge shaft 68, without being affected by the biasing force of the tension member.

FIG. 8 is a graph showing the relationship between force and movement of the lower end of a display device, where the horizontal axis represents the opening angle of the second connecting assembly, and the vertical axis represents force generated according to that angle.

Referring to FIG. 8, line 32 represents the force f₁ of the moment that is generated by the tension member 63 to pivot the lower end of the display portion downward, line 31 represents the force f₂ of the moment that tends to continue to the pivoting due to the weight of the display device when the lower end of the display device is pivoted upward, and line 33 represents the combination of the two forces f₁ and f₂.

Resultantly, in order for a user to pivot the lower end of the display device in FIG. 8 upward, the user exerts a force that exceeds the lower limit of a static friction range (W) for line 33. Conversely, to pivot the lower end downward, a downward force must be exerted that exceeds the upper limit of the static friction range (W) for line 33. The point exceeding the upper limit of the static friction range (W) may be referred to as the point at which the display device begins to pivot due to the moment of its weight—that is, the point where auto-tilting begins, even when there is no external force exerted on the display device.

Of course, this line graph only depicts approximate moments, and while various displacements are possible, such as the tilt of line 32 being altered through changing the tension coefficient of a spring, FIG. 8 is a simplified depiction to allow understanding of the operation of the second connecting assembly according to the present embodiment.

To further describe FIG. 8, if the tension member 63 were not present, a force corresponding to the distance between line 31 and the upper limit of the static friction range (W) would have to be exerted. However, if the tension member is added, the force that must be exerted for pivoting the lower end of the display device to its initial upward position can be reduced.

Conversely, when a user pushes the lower end of the display device, the tension member changes from a contracted state to an expanded state. Here, the user must exert greater force, so that the user is informed of the display device having reached a position proximate to the wall. Accordingly, the user can control the degree of pressing force exerted on the display device to gradually push the device in and prevent an abrupt collision between the display device and the wall, thereby increasing reliability of the device.

The reason for making the tension member 63 exert biasing force only when the display device is pulled or pushed is based on the limitation of a user having to exert a large amount of force when initiating the act of pulling the lower end of the display device, and the limitation of excessive force being applied (due to the weight of the display device) when the lower end of the display device is pushed.

Specifically, when a user exerts force when pushing the lower end of the display device, the force exerted by the user and the weight of the display device are simultaneously applied. The resulting increase in velocity can cause a collision between the rear of the display device and other components, which may result in equipment malfunction, etc. Therefore, after a user pushes the lower end of a display device a certain distance, the tension member is made to change from a compressed state to an expanded state to not only alert the user, but also apply resistance to the force pressing in the display device and virtually eliminate shock incurred on the display device when it is fully pushed in.

For similar reasons, the first connecting assembly supporting the upper end of the display device, and the second connecting assembly supporting the lower end thereof are configured as mutually different mechanisms.

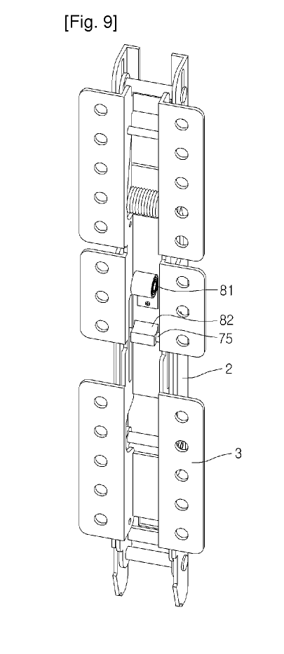

FIG. 9 is a perspective view showing the configuration of a second connecting assembly according to present embodiments. Since elements in the present embodiment that are the same as in the preceding embodiment have already been addressed, the following description will be centered around differing elements.

Referring to FIG. 9, a pushing portion 82 is mounted on the guide shaft 75, and a plate spring 81 is mounted at a position on the fixing bracket 3 separated a predetermined distance above the pushing portion 82. The plate spring 81 is unwound or wound by the pressing function of the pushing portion 82, so that the pushing portion 82 exerts a pressing force downward.

1. A supporting apparatus for a display device, the supporting apparatus comprising:
a fixing bracket;
a set bracket connected to the display device and capable of tilting with respect to the fixing bracket; and
a connecting assembly connecting the set bracket and the fixing bracket, wherein the connecting assembly comprises a tension member generating biasing force over a portion of a tilting range of the display device.

2. The supporting apparatus according to claim 1, wherein the tension member moves elastically in upward and downward directions.

3. The supporting apparatus according to claim 1, wherein the connecting assembly further comprises:
a connecting member pivotably connected to the set bracket and connected to the fixing bracket to be capable of sliding and pivoting; and
a supporting member pivotably connected to the connecting member and the fixing bracket, wherein the tension member is elastically deformed during sliding of the connecting member.

4. The supporting apparatus according to claim 3, further comprising:
a guide shaft connecting the connecting member and the fixing bracket; and
a shaft connecting the supporting member and the fixing bracket, wherein the tension member has one end fixed to the shaft and the other end selectively supported on the guide shaft.

5. The supporting apparatus according to claim 4, wherein the tension member comprises:
a tension portion that elastically moves; and
a guide portion extending from one end of the tension portion, for guiding movement of the guide shaft.

6. The supporting apparatus according to claim 5, wherein the guide portion defines a moving space for the guide shaft, and the guide shaft moves within the moving space.

7. The supporting apparatus according to claim 5, wherein the guide portion comprises a bent portion selectively contacting the guide shaft, the bent portion moving in concert with the guide shaft when the guide shaft contacts the bent portion.

8. The supporting apparatus according to claim 5, wherein
the tension portion expands when the display device is completely tilted in one direction,
the tension portion contracts during tilting of the display device in the opposite direction, and
the guide shaft moves along the guide portion when the display device is tilting in the opposite direction, with the tension portion completely contracted.

9. The supporting apparatus according to claim 5, wherein
the tension portion maintains a contracted state when the display device is completely tilted in one direction,
the tension portion maintains the contracted state until the display device is tilted by a predetermined angle in the opposite direction, and
the tension portion expands when the display device is tilted past a predetermined angle in the opposite direction.

10. The supporting apparatus according to claim 4, wherein the fixing bracket comprises a slot for guiding upward and downward movement of the guide shaft.

11. The supporting apparatus according to claim 1, wherein the connecting assembly is a lower connecting assembly, and the supporting apparatus further comprises an upper connecting assembly connecting the set bracket and the fixing bracket.

12. The supporting apparatus according to claim 11, wherein the upper connecting assembly comprises:
a first arm pivotably connected to the set bracket; and
a second arm pivotably connected to the fixing bracket, wherein
the first arm and the second arm are pivotably connected through a hinge shaft, and the tension member is provided on the hinge shaft.

13. The supporting apparatus according to claim 12, wherein the tension member of the upper connecting assembly exerts biasing force in a folding direction of the upper and lower arms.

14. A supporting apparatus for a display device, the supporting apparatus comprising:
a fixing bracket;
a set bracket connected to the display device to be capable of tilting with respect to the fixing bracket;
a connecting member pivotably connecting the set bracket and the fixing bracket;
a supporting member pivotably connected to the connecting member and the fixing bracket; and
a tension member selectively generating biasing force during tilting of the display device, wherein
the display device is capable of tilting in both directions,
the tension member moves elastically in one direction within a predetermined tilting range during tilting of the display device in the one direction, and the tension member moves elastically in the opposite direction within a predetermined tilting range during tilting of the display device in the opposite direction.

15. The supporting apparatus according to claim 14, further comprising:
a guide shaft connecting the connecting member to the fixing bracket; and
a slot formed in the fixing bracket, for guiding sliding of the guide shaft.

16. The supporting apparatus according to claim 15, wherein
the tension member comprises:
a tension portion that moves elastically; and
a guide portion extending from the tension portion, wherein the guide portion guides upward and downward movement of the guide shaft.

17. The supporting apparatus according to claim 16, wherein
the tension portion maintains an expanded state when the guide shaft has completely moved to one end of the slot,
the tension portion contracts during moving of the guide shaft toward the opposite end of the slot, and
the guide shaft moves along the slot and the guide portion when the tension portion is completely contracted.

18. The supporting apparatus according to claim 16, wherein
the guide portion comprises a bent portion selectively contacting the guide shaft,
the tension portion expands or contracts when the guide shaft contacts the bent portion, and
the guide shaft moves with respect to the guide portion when the guide shaft is separated from the bent portion.

19. The supporting apparatus according to claim 14, further comprising a connecting assembly connecting an upper end of the set bracket to the fixing bracket, wherein the connecting assembly comprises:
a first arm connected to the set bracket;
a second arm connected to the fixing bracket and the first arm;
a hinge shaft enabling pivoting of the first arm and the second arm; and
a tension member provided on the hinge shaft.

20. The supporting apparatus according to claim 19, wherein the tension member of the connecting assembly exerts biasing force in a folding direction of the first and second arms.
